(19) United States
(12) Patent Application Publication
(10) Pub. No.: US 2003/0101670 A1
(43) Pub. Date: Jun. 5, 2003

(54) Foundation from bracket and method

(76) Inventor: Morris Houston Gustin, Alameda, CA (US)

Correspondence Address: MORRIS H. GUSTIN, III, 1030 BROADWAY, ALAMEDA, CA, 94501, US

(21) Appl. No.: 10/011,178

(22) Filed: Dec. 5, 2001

(51) Int. Cl. E04G 11/06; E02D 27/00; B42F 13/00

(52) U.S. Cl. 52/293.1; 249/34; 249/33

(57) ABSTRACT

A pre-fabricated building foundation form assembly is installed beneath a pre-existing temporarily supported structure in its final position, and a footing dug below the line of the lowest building timber. A rigid sheet form element is positioned along the upper and outside perimeter side portion of the lowest building timber. The brackets are positioned over the lowest timber and against the sheeting at specified intervals and held in place with connectors. Adjustable supports are attached to the brackets and connectors attach brackets to sheeting. J-bolts along with structural steel are installed. A rigid sheet form element is laterally positioned along the inside perimeter of the inner side of the brackets and held with connectors, which completes the suspended enclosure. A flowable and settable foundation material fills the space within the enclosure and extends essentially continuously upwardly from the footing below the site surface to meet the lower surface of the lowest floor timber to support the building thereon once the foundation material has cured. The footing below the rigid sheet form element has a lateral width greater than the space between the portions of the enclosure to form a foundation footing of suitable width.

### BACKGROUND

1. Field of Invention

The invention relates to a poured concrete foundation bracket apparatus, and method of installation thereof, particularly for use with existing buildings or floor assemblies.

This bracket temporarily supports a foundation form for pouring a one up to a three-story foundation. The bracket assembly comprises the main bracket and two adjustable supports. The foundation form bracket assembly is secured to the lowest timber of the building usually referred to as the mudsill and extends over and downward toward the site surface and attaches to rigid sheet panels. The bracket is used to hold and suspend sheet panels so as to create a relatively enclosed space in which a flowable concrete mixture is poured to specifications at an opening left at the top of the enclosure. The form assembly uses a reusable and adjustable bracket that attaches sheet panels rapidly, thus reducing time required preparing the site. The bracket's strength also eliminates the need for heavy and intricately built forms or even form ties normally needed to restrict concrete flow movement and resist forces from the concrete before it sets. Further, due to the strength and simplicity of the brackets, the number of brackets needed to support the form is minimal to still retain form integrity against the force of the concrete and the ease of installation thereby reduces labor and time. When the concrete sets, the bracket supports and rigid sheet forms can be just as easily and quickly removed to be reused for another job. The finished product is a neat, smooth and vertical foundation wall.

2. Description of Prior Art

The current method of foundation bracing formation and reinforcing is in using extensive amounts of lumber cut into customized support forms and stakes. This procedure is tedious, inexact, labor intensive, wasteful, and therefore very expensive in many aspects.

It is very tedious, as the bracing requires many hours to purchase lumber and then to construct the forms and stakes. Forming bracing from lumber varies for each building foundation shape, surrounding ground type and clearance. As a result, bracing has to be customized. Considerable time is needed in cutting and forming sturdy form supports, bracing and stakes. These forms are very heavy in order to be sufficiently durable and thereby require additional manpower and supporting equipment to position. Forms are typically nailed to braces, which are positioned with stakes that are hammered into the ground. Various surfaces and available surface clearances can further complicate this forming method which is eliminated with this new bracket and suspended light rigid sheet form technique.

Estimating the lumber necessary to create sufficient and adequate supports, bracing, and stakes varies with the surrounding ground type and foundation height to be constructed. This estimating is inexact when trying to determine how many supports, braces, and stakes and of what size and shape are necessary to maintain the wood form enclosure strength. When cement is poured into the form, a tremendous amount of pressure is exerted outward against the form enclosure. Should the ground bracing give way and cause the form to begin to collapse, the need for extra manpower, stakes, and supports, have to be available to quickly remedy the situation. It is, therefore, always a guessing game to knowing if the supports, bracing and stakes, which are used, will be adequate.

Tremendous waste occurs with formation of each new foundation using the current methods. First, lumber is over purchased in quantity because the science of staking is not consistent and determined by too many variables such as surface and ground type, angle of supports, length of stakes, type of nails used, height of foundation desired and accompanying foundation wall form. Also, extra stakes and braces are formed to be available to ensure the stability of the form to be constructed. It is always necessary to be prepared with extra stakes and supports should the ground and or the form collapse under the pressure of the flowing and setting cement that will exert an outward pressure force on the form.

Because each foundation is unique due to building shape and surrounding ground and clearance, the ground crew must customize each form. This requires additional expense in man-hours to build these unique supports, braces, and stakes, then install them to hold the wood form in place. By this method, extensive time needs to be devoted to customizing. Also, there is usually an added expense required to have experienced personnel to oversee that the work is done correctly. Worker's accidents due to poor workmanship leading to accidents arising from forms collapsing and injuring workers must always be avoided.

Finally, there is a tremendous amount of debris that has to be removed. Once the foundation form has been poured, the customized supports, bracing, and stakes are no longer of any use and become debris. The expense in man-hours of dismantling the forms, bracing, and stakes, and then dumping the wood and nails at a repository, is an expensive waste. This is repeated at each job.

### SUMMARY

This bracket is for existing building structures, which are replacing their foundations. The bracket is used to hold and suspend a form to an existing structure so as to create an enclosed space in which concrete can be poured to specifications. This bracket simplifies the existing ways in which forming foundations is presently done.

### OBJECTS AND ADVANTAGES

Accordingly, several objects and advantages of my invention are the time and the money saved in construction of the new foundation. A building foundation form assembly according to the invention comprises a minimal number of brackets spaced apart along the new floor assembly and temporarily attached at the new floor assembly as well as to suspended rigid sheet form elements. The brackets connecting the rigid sheets create a suspended laterally spaced enclosure. The rigid sheets extend close to the site surface. No additional supports are needed.

This bracket and method is so structurally sound that it eliminates the need to construct extensive wood form supports. The bracket requires few tools to be installed and removed. It saves time because of the speed and ease of installation that it:

reduces workforce per job so more jobs can be done easily by fewer people.

reduces work hours from days to a few hours.

allows for either an inside or outside perimeter pour of concrete to be put in place quickly and easily.

Finances saved due to this method is further evident in dollars saved in:

purchasing fewer wood form materials per foundation job.

not having form supports to discard once the job is completed, and thereby reducing additional waste reclamation expense. Currently all wood supports are discarded and unfit for reuse.

reducing workforce per job means less manual labor expense per job.

The reduction of demand on natural resources helps the environment. Under the current method in use, most of the supporting form material is wood for forms, bracing and supports and metal for nails. Currently, considerable amounts of nails and very heavy lumber are used to form the support of each foundation assembly. This reusable bracket assembly only requires lumber for the rigid sheet forms and a few screws instead of nails, and consequently would allow a substantial savings to the demands on the natural environment both from our forests and as a waste management perspective. Also, the screws as well as the rigid sheets can be removed and reused for future jobs.

Still further objects and advantages will become apparent from a consideration of the ensuing description and accompanying drawings.

### DESCRIPTION OF THE DRAWINGS

FIG. 1 is a perspective view of the preferred embodiment for a single story foundation.

FIG. 1A is an exploded view of FIG. 1.

FIG. 2 is a perspective view of the main bracket.

FIG. 2A is a top view of the main bracket.

FIG. 2B is an end view of FIG. 2.

FIG. 3 is a perspective view of a standard adjustable support.

FIG. 3A is a side view of FIG. 3.

FIG. 3B is an end view of FIG. 3.

FIG. 4 is an exploded view of FIG. 1 with adjustable supports positioned for a two-story foundation.

FIG. 5 is an exploded view of FIG. 1 with adjustable supports positioned for a three-story foundation.

FIG. 6 is a simplified fragmented transverse section through a completed foundation according to the invention before pouring concrete and before removing the preferred embodiment and rigid wall sheet.

FIG. 6A is a front view of FIG. 6.

FIG. 6B is a top view of preferred embodiment in place with rigid plywood sheeting.

FIG. 6C is a top view of preferred embodiment but with bracket reversed for outside perimeter pour.

FIG. 6D is an end view of main bracket attached to outer plywood sheeting.

FIG. 6E is a top view of FIG. 6D.

FIG. 6F is a side view of multiple brackets in place and holding outer sheeting in place

FIG. 6G is a side view of outer sheeting being held by bracket with outer standard support attached.

FIG. 7 is a simplified fragmented transverse section through a completed foundation according to the invention after the concrete is poured but before either the preferred embodiment or rigid wall sheeting is removed.

REFERENCE NUMERALS

| | |
|---|---|
| 17 top piece | 81 small wood screw hole on main bracket |
| 19 end piece | 83A small wood screw hole on support |
| 21 pin bolt | 90 J-Bolt |
| 22A side hole main bracket | 92 nut |
| 22B side hole main bracket | 94 single large hole |
| 22C side hole main bracket | 120 trench |
| 32C side hole of support | 130 site surface |
| 40 standard side support | 140 trench depth |
| 50 rigid plywood sheet | 145 trench width |
| 60 mudsill | 150 opening of the enclosure |
| 80 wood screw | 180 flowable cement mixture |

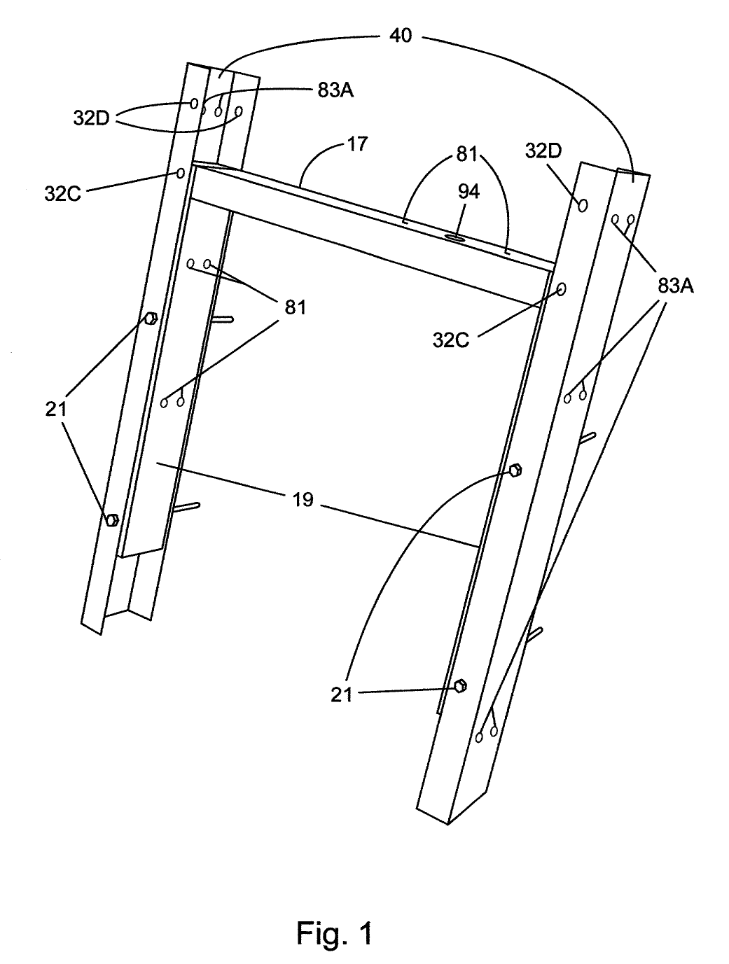

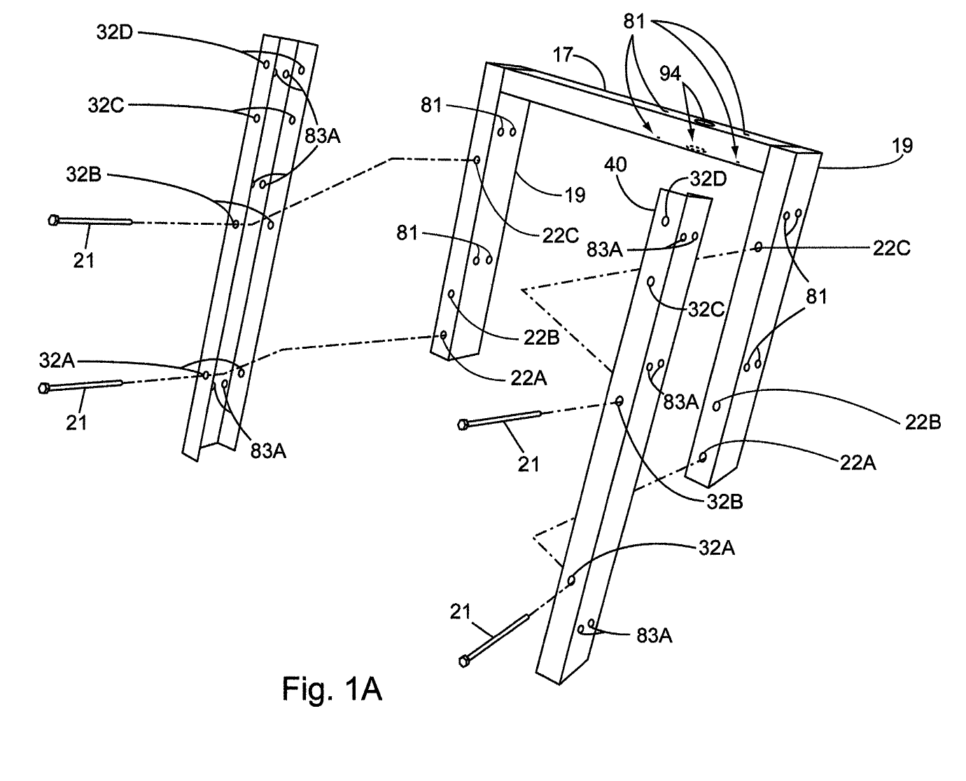

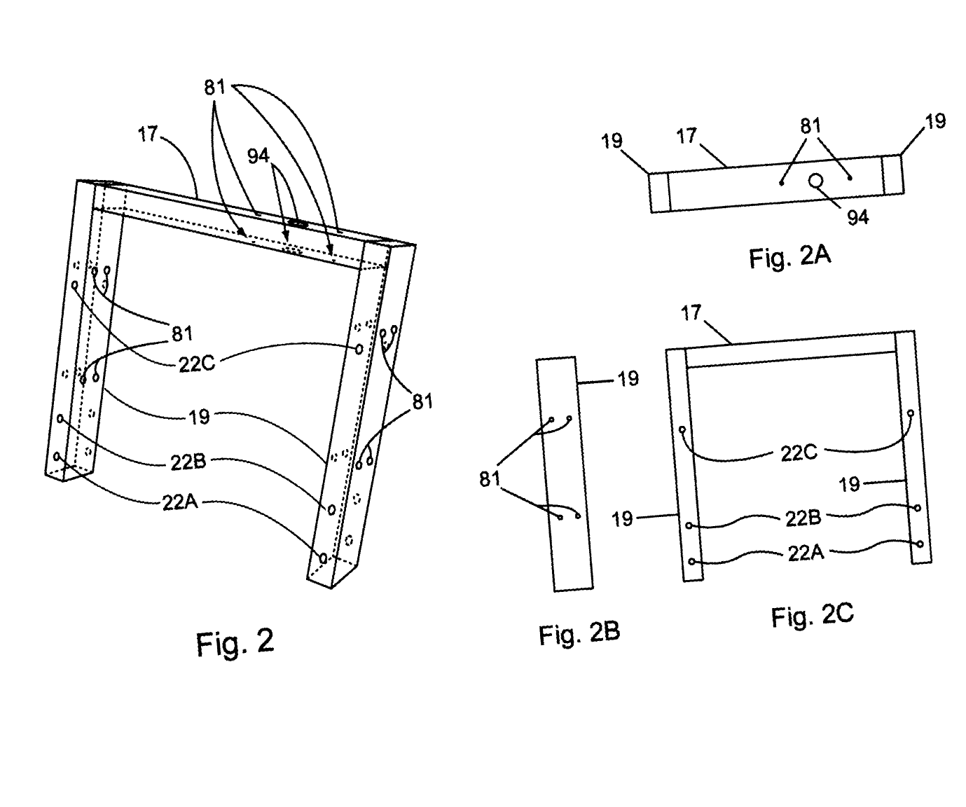

### PREFERRED EMBODIMENT—DESCRIPTION FIGS. 1-2

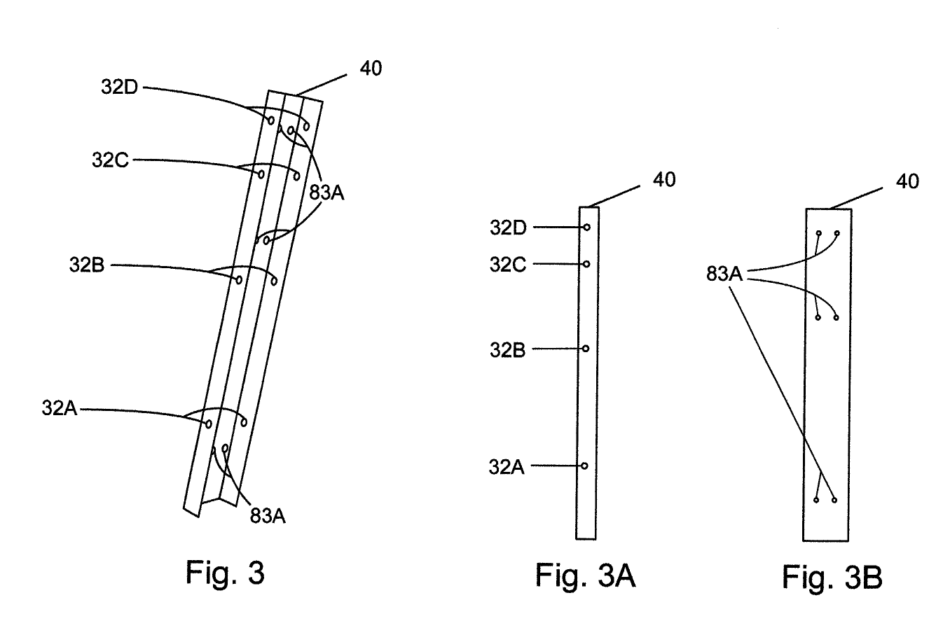

The invention consists of three parts, a main bracket FIG. 2 (perspective view), two adjustable standard side supports FIG. 3 (perspective view), and two pin bolts 21 on each side to hold the adjustable standard side supports 40 onto the main bracket FIG. 1 and FIG. 1A. FIG. 3 shows one example of a standard side support 40. Standard side supports 40 are universal and interchangeable on the main bracket FIG. 2.

Conventional tools can be used for drilling, cutting and welding steel to construct the bracket assembly. The main bracket FIG. 2 is formed from rectangular tubing steel of 1/8 inch (3.275 ) thickness. Each standard side support 40 as seen in FIG. 3 is formed from 1/8 inch (3.275 mm) thickness steel that fits over the rectangular tubular steel on the outer three sides. Using 1/8 inch (3.275 mm) as the standard steel thickness, outside dimensions of the rectangular tubular steel measures 2 inches (50.08 mm) wide, by 1 inch (25.4 mm) side height. The steel used for each standard side support 40, fitting over the rectangular tubular steel, has an outer measurement of 1 inch (25.4 mm) side, by 2¼ inches (57.15 mm) wide, by 1 inch (25.4 mm) side, by 17 inches (43.18 cm) in length. As seen in FIG. 2, the main bracket is composed of a top piece 17 of tubular steel and two end pieces 19 of tubular steel welded to the ends of the top piece 17 and forming right angles at each junction. Thus, the main bracket FIG. 2 is a rigid one-piece U-shaped unit. FIG. 2C is a side view of FIG. 2. Length of the top piece 17 is 11 inches (27.04 cm). FIG. 2B is an end view of FIG. 2 that shows the end piece 19. Each end piece 19 measures 1 inch (25.4 mm) side, by 2¼ inches (57.15 mm) wide, by 12 inches (30.48 cm) in length. The overall bracket length across the top is 13 inches (330.2 mm) which includes the measurement across the top of the two welded end pieces 19 as in FIG. 2A top view.

On each end piece 19 and along the one inch (25.4 mm) width as in FIG. 2C are matching side holes 22A through 22C. All holes 22A through 22C are 1/4 inch (6.35 mm) drilled horizontally through both one inch sides of each end piece 19 to allow the shaft of a pin bolt 21 to pass through both. Measuring on center, holes 22A are eleven inches (279.4 mm) from the top of bracket top 17. Next, holes 22B are nine inches (228.6 mm) from the top of bracket top 17. Finally, holes 22C are 4¾ inches (120.65 mm) from the top of bracket top 17.

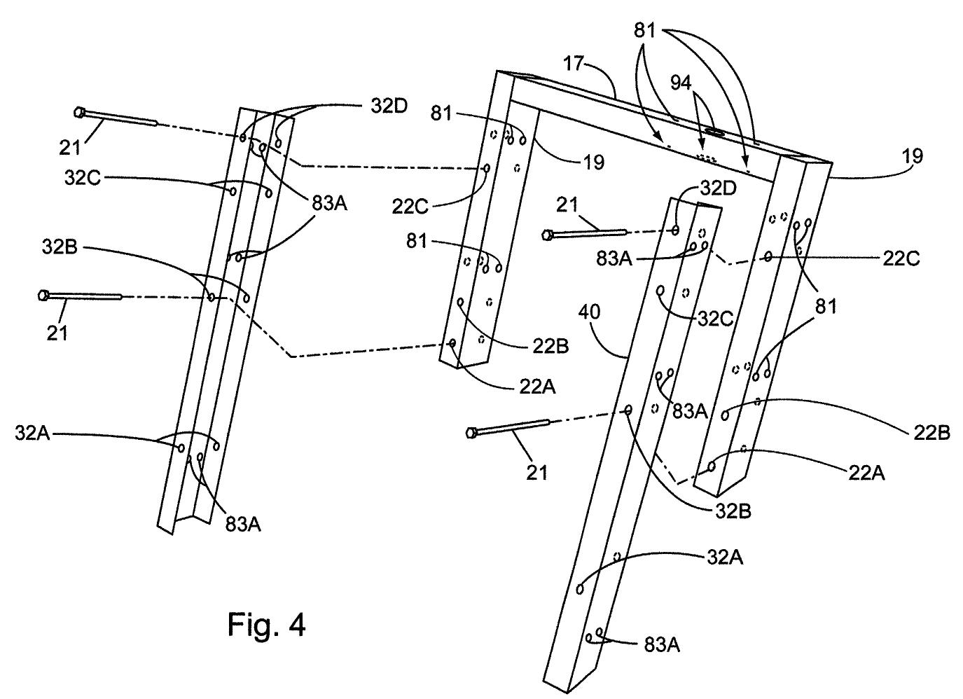

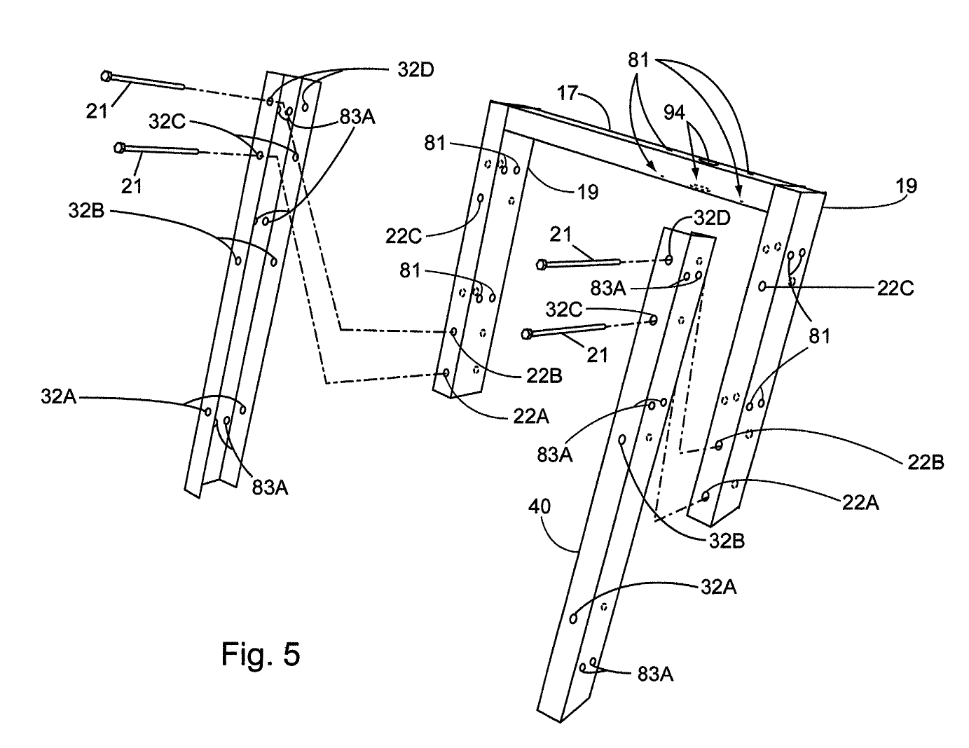

On each standard side support 40 along the one inch (25.4 mm) width, as in FIG. 2A, are side holes 32A through 32D, all 1/4 inch (6.35 mm) drilled horizontally through both sides of the tubing. All standard side supports 40 are universal and interchangeable with each other and with each end piece 19 of FIG. 1. Measuring down the centerline of the one inch (25.4 mm) width on any standard side support 40, holes 32A are 13 inches (330.2 mm) from the top of support 40. Continuing further, holes 32B are 7⅛ inches (180.975 mm) from the top of side support 40. Next, holes 32C are 3 inches (76.2 mm) from the top of side support 40. Finally, holes 32D are 1 inch (25.4 mm) from the top of side support 40. With side support 40 aligned against each end piece 19, each side support 40, as seen in FIG. 1 and FIG. 1A, is attached to each end piece 19 by two pin bolts 21. Each pin bolt 21 is a steel 1/4-inch (25.4 mm) bolt size, measuring three inches (76.2 mm) long, with a hexagonal head. Side holes allow the pin bolts 21 to pass through the side holes of the support 40 which overlap end piece 19, but still be held by the hexagonal head. By aligning different side holes 22A through 22C of the main bracket FIG. 2 with side holes 32A through 32D of support 40 FIG. 3, the bracket assembly may be adjusted from a single story foundation assembly FIG. 1, up to a three story foundation assembly as will be described in FIG. 4, and FIG. 5. The preferred embodiment of the bracket assembly of the present invention is illustrated in FIG. 1 for a single story foundation and is the focus of the discussion. Additional embodiments are seen in FIG. 4 for a two-story foundation and FIG. 5 for a three-story foundation, which will be discussed later and demonstrates some of the versatile features of the invention.

Wood screws 80 are used to hold the preferred embodiment FIG. 1 to the forming sheeting materials and new mudsill 60. It is recommended to use conventional steel wood screws 80 that are 1/8 inch (3.275 mm) by 1 1/2 inches (38.1 mm) long. Any type of screwdriver tool may be used. A Philips head screw is preferred. On the broad 2 inch (50.8 mm) side of each main bracket FIG. 2 and FIG. 2B, are horizontally drilled ⅛ inch (3.275 mm) small wood screw holes 81. The holes pierce both sides of the tubular steel. Looking at FIG. 2A, the main bracket top piece 17 as connected to each end piece 19, and measuring from the outside center right edge of the top piece 17 lengthwise along the center line towards the center of the top piece 17, two small wood screw holes are drilled through the main bracket FIG. 2 and FIG. 2A. One small wood screw hole along the centerline length of FIG. 2A is 2¾ inches (69.85 mm) from the outer top end. Measuring further along the centerline is another small wood screw hole on FIG. 2A. which is 4½ inches (114.3 mm) from the same outer center end. Then down the center line of both end pieces 19, FIG. 2 and FIG. 2B, are horizontally drilled additional small wood screw holes 81 through both broad 2 inch (508 mm) sides of the tubular steel. A pair of small wood screw holes 81 on the main bracket FIG. 2 and FIG. 2B are horizontally drilled 3 inches (76.2 mm) from the top of both end pieces 19 and spaced 1/2 inch (12.7 mm) apart. Continuing further on the center line, a pair of small wood screw holes 81 on the main bracket FIG. 2 and FIG. 2B are horizontally drilled 7 inches (177.8 mm) from the top of each end piece 19.

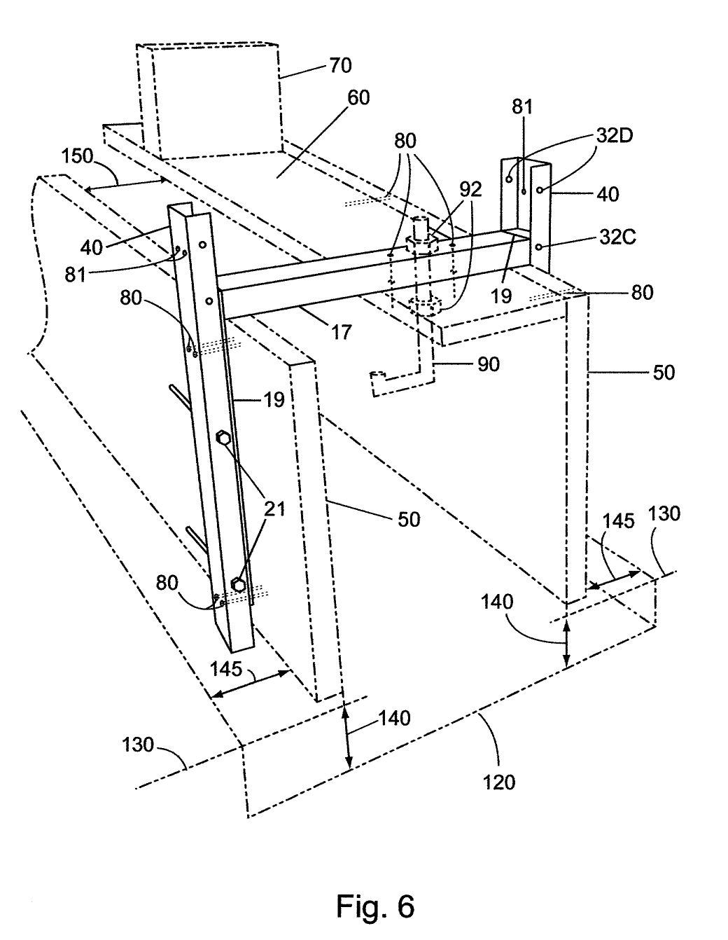

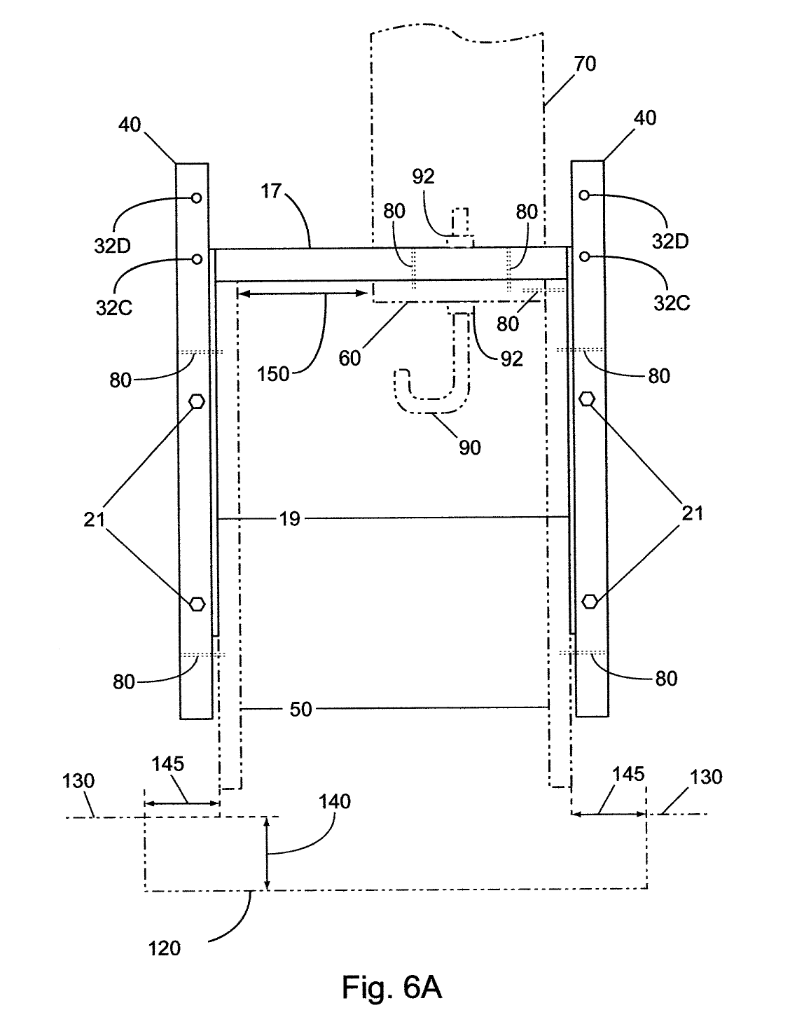

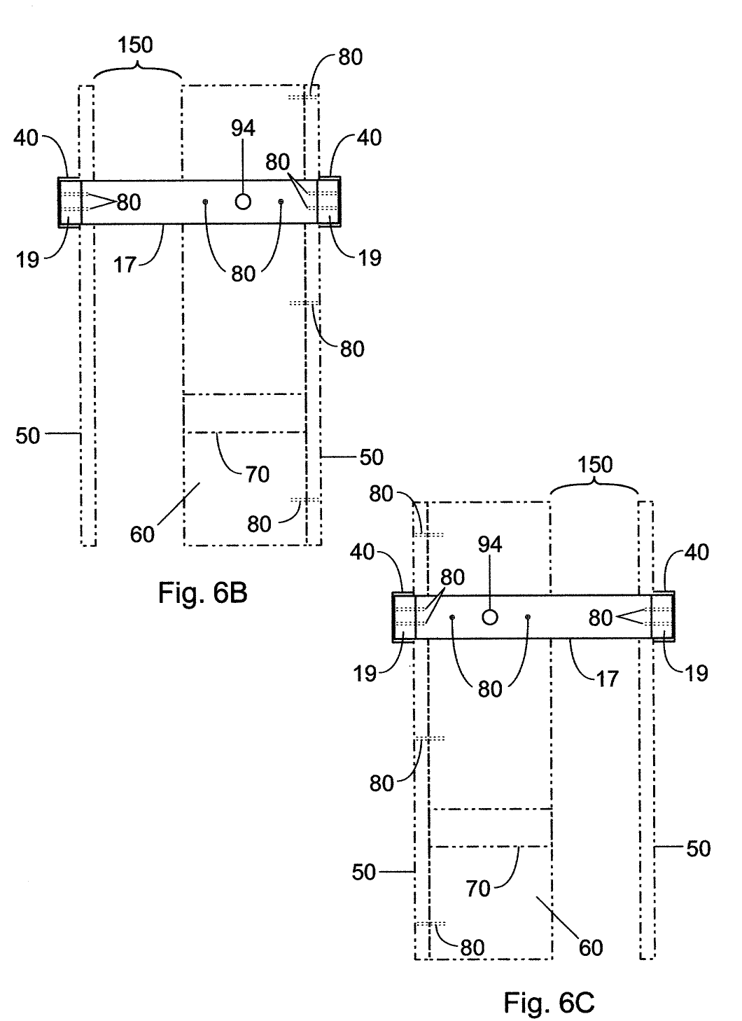

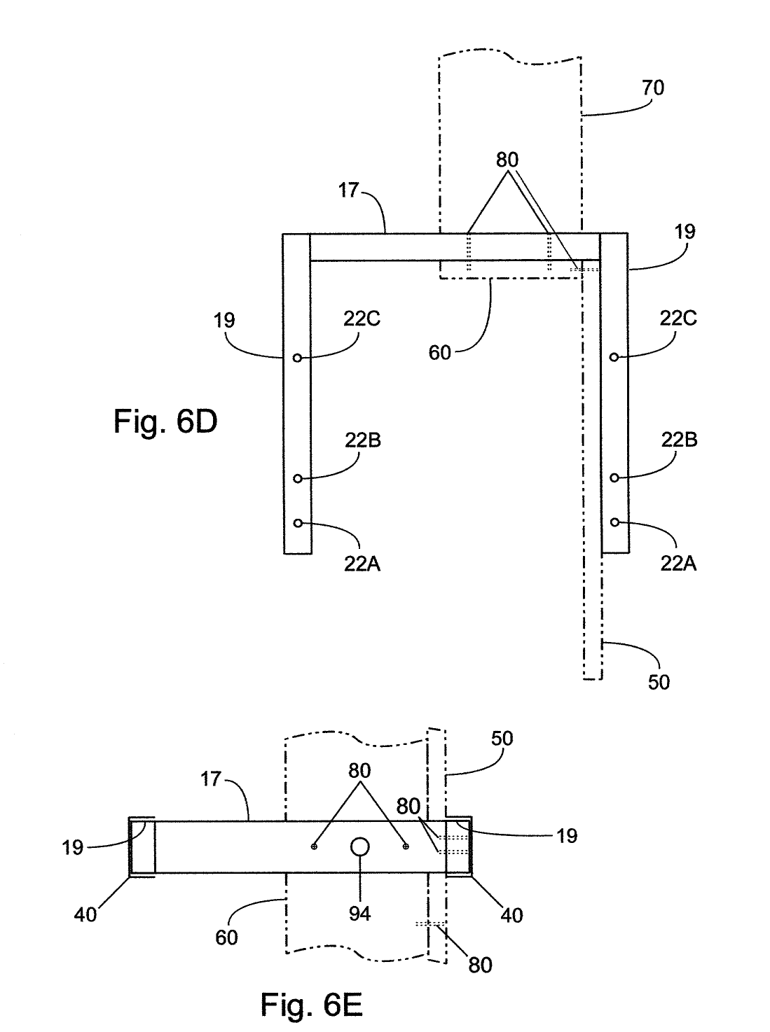

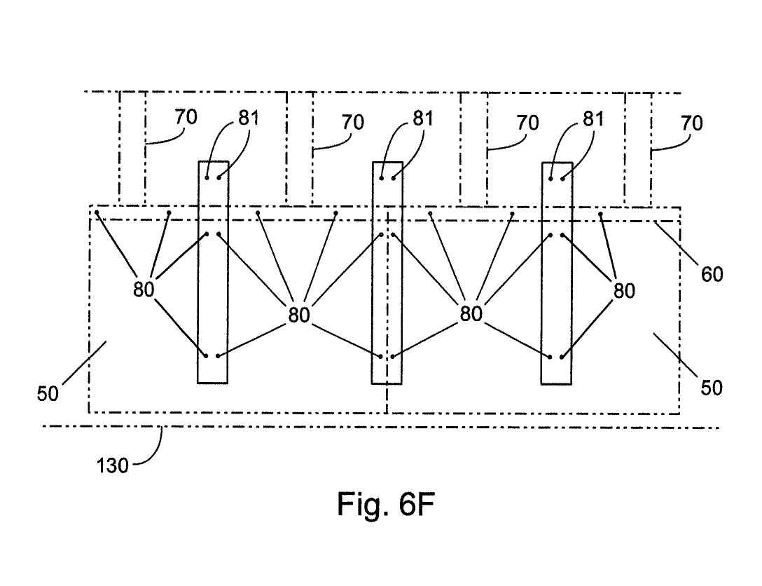

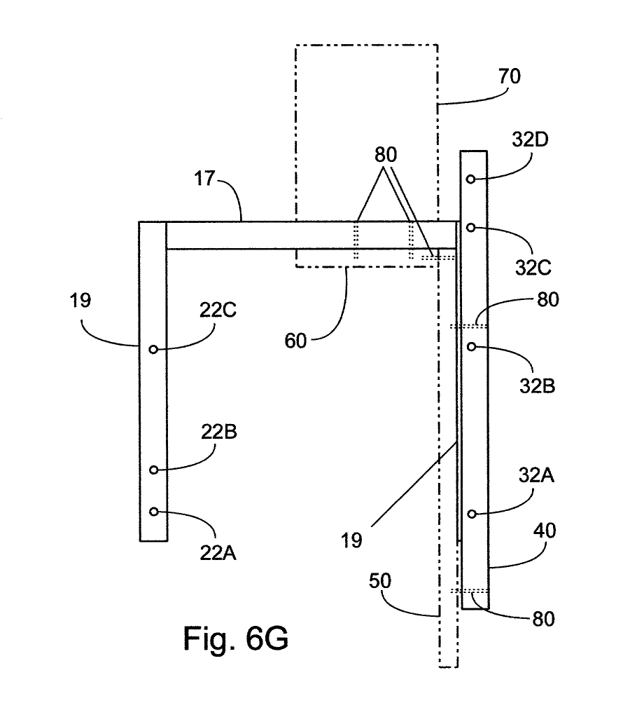

Similarly in FIG. 3 and FIG. 3B, on the 2¼ inch (57.15 mm) side supports 40, are 1/8 inch (3.275mm) small wood screw holes on support 83A for wood screws 80. These wood screw holes on supports 83A are drilled 1/2 inch (12.7 mm) apart as measured along the center line. The first pair of small wood screw holes on support 83A is drilled at 1⅛ inches (28.575 mm) from the top. Continuing in measuring further down the centerline, another pair of small wood screw holes on support 83A is drilled 5 7/16 inches (138.1125 mm) from the top. The last pair of small wood screw holes on support 83A is drilled 14¾ inches (374.65 mm) from the top. The recommended length of wood screw 80 is 1½ inches (38.1 mm). Those small wood screw holes 81 on top of the top piece 17 are used to fasten the main bracket FIG. 2 to the new mudsill 60 in FIG. 6, which will be discussed later. When side supports 40 are attached to the main bracket FIG. 2 with pin bolts 21 to form a complete assembly, applicable small wood screw holes on support 83A align automatically with applicable small wood screw holes of the main bracket FIG. 2. These aligned holes act as entry points to attach the preferred bracket assembly FIG. 1 to the plywood rigid sheets 50 used to form the enclosed space between which the concrete will flow and form the new foundation.

The thickness of each rigid plywood sheet 50 should be uniform and between 5/8 (15.875 mm) to 3/4 inch (19.05 mm). These rigid plywood sheets 50 are rectangular lengths, which are cut by conventional method from standard size sheets to meet code specifications sizes for height of the new foundation wall. Standard size sheets are available in 4 feet (121.92 cm) wide by 8 feet (243.84 cm) long lengths. The preferred embodiment is positioned to accept sheets for a one-story foundation wall height of 18 inches (45.72 cm). To determine the number of 8 foot (243.84 cm) lengths of sheets is determined by the length of the inside and outside perimeter lengths of the foundation to be constructed. The outside perimeter of the foundation is the measurement of the outside perimeter edge of the new mudsill 60. The inside perimeter of the foundation is the measurement of the inside perimeter of the inside edge of the bracket framing formed by the positioned brackets.

Wood screws are used for tacking purposes. Using wood screws 80 allows the rigid plywood sheets 50 to be used, dismantled, and then reused quickly many times to reduce debris and accompanying waste expense. The screws 80 are also used to attach the bracket assembly FIG. 1 to the rigid plywood sheets 50. Wood screws 80 should be long enough to pass through aligned holes in the standard side support 40 with end piece 19 and attach into the rigid plywood sheets 50 but not penetrate through the plywood material to avoid damaging the smooth sides of the enclosed space to be formed. Any type of standard steel screws and screwdriver tool may be used. A Philips head screw is preferable.

The single large hole 94, which is 5/8 inches (15.875 mm), is drilled through both sides of the tubing of the top of the main bracket 17 of FIG. 2. The single large hole 94 is aligned on the bracket along with the two small wood screw holes 80 on either side, so as to rest over the center of the width of the new mudsill 60 once the bracket is in place. With bracket properly attached to new mudsill 60 and on whatever specifications is required by code, this large hole 94 is the hole through which either a 1/2 inch (12.7 mm) or 5/8 inch (15.875 mm) J-Bolt 90 is passed through bracket and attached to the new mudsill 60 in FIG. 6 and FIG. 6A which will be discussed later.

### FIG. 1—Assembly

FIG. 1 is an example of a preferred assembly for a single story foundation. The invention for the preferred assembly FIG. 1 is composed of the main bracket FIG. 2, two standard supports 40 as in FIG. 2 and four pin bolts 21. Standard side supports 40 are connected by slipping one standard support 40 over one end piece 19 lining up the holes 22A with 32A and inserting a pin bolt 21. Then insert another pin bolt 21 at holes 32D with 22B. Repeat these steps for the other end piece 19 of the main bracket FIG. 2 to complete assembly.

### FIGS. 4-5—Additional Embodiment Assemblies

FIG. 4 demonstrates an assembly for a two-story building foundation. To prepare assembly, slip one standard side support 40 over an end piece 19 lining up the side holes 22C with 32D and insert a pin bolt 21. Then insert another pin bolt 21 at holes 22A with 32B. Repeat for the other standard side support 40 and end piece 19 to complete the assembly.

FIG. 5 demonstrates an assembly for a three story building foundation. Prepare assembly in a similar manner slipping one standard side support 40 over an end piece 19 and lining up the holes 22B with 32B and inserting a pin bolt 21. Then insert a pin bolt 21 through holes 22A with 32C. Finish the other side, joining end piece 19 with a standard side support 40 by two pin bolts 21, in a like manner.

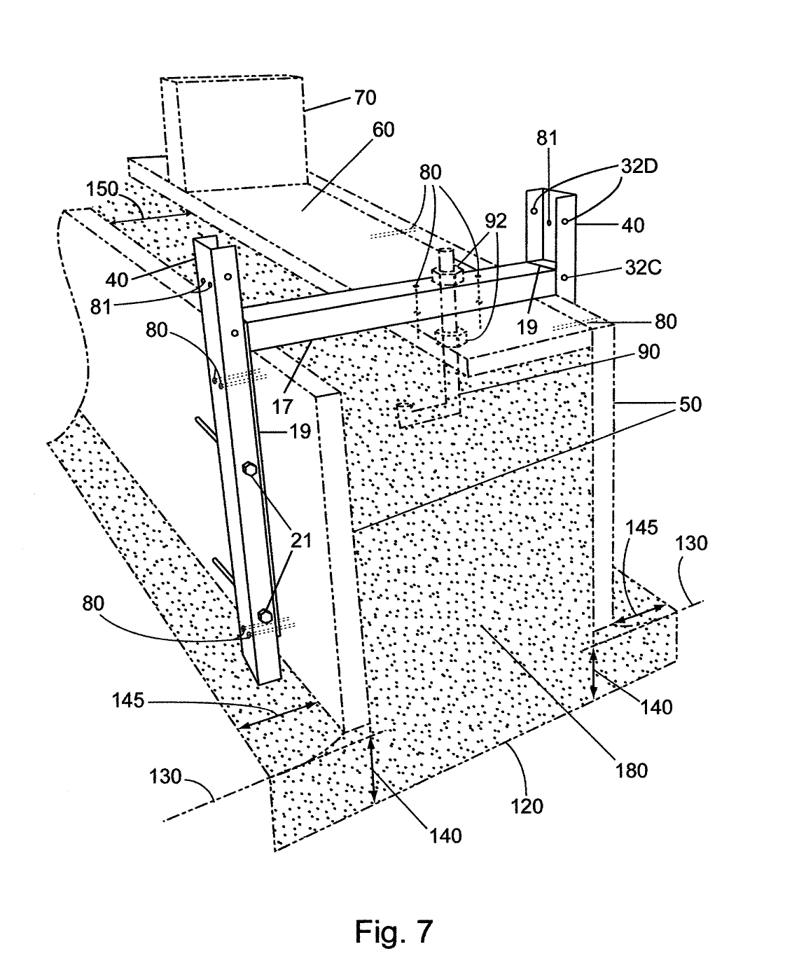

### FIGS. 6-6A-7

FIGS. 6 and 6A demonstrate what the foundation form bracket looks like once installed but without structural steel in place. Structural steel is omitted as code requirements vary. The opening of the enclosure 150 for the cement mixture 180 to flow through is drawn for an inside perimeter foundation pour. FIG. 7 shows how the flowable cement mixture 180 might appear as it has settled into the trench 120 dug below the site surface 130.

### Preferred Embodiment—Operation

The site surface 130 does not require extensive work prior to installing as the invention operates in a suspended position. The operation and use of this invention is simple and straightforward. Major obstructions are usually removed. The surface should be generally leveled, but trenching can be cut so as to reduce sloping of foundation wall. Any organic material should be removed. There is no requirement for specific treatment or accurate trenching of the ground underneath the foundation. This apparatus is primarily designed to be used where trenching is required as part of the foundation. Generally, the trench 120 can be dug using conventional techniques. The trench 120 follows the path of the new foundation and provides additional footing. The trench 120 would be sufficiently wider 145 than the foundation form and deep enough 140 below the site surface 130 to meet code requirements. No conventional formwork is required for the trench. The existing floor structure is temporarily supported on adjustable jacks and is leveled using conventional techniques to set the lowest level of the floor assembly 70 in its final position. The existing foundation is removed via conventional techniques along with the existing mudsill and a new mudsill 60 is attached to the floor assembly 70. When the new mudsill 60 is in place as in FIG. 6, the foundation form bracket assembly, as completed in FIG. 1, can begin to be installed as follows.

Begin attaching sheets 50 lengthwise with wood screws 80 along the perimeter of the outside edge of the new mudsill 60. Each sheet 50 length is butted to the next. The top edge of the sheet is kept flush with the top of the new mudsill 60. Wood screws 80 are screwed into the rigid plywood sheeting 50 approximately every two feet (660 mm), and into the new mudsill 60. Very few screws 80 are necessary and only for tacking purposes, as the invention and the pressure of the concrete will hold the completed assembly in place. Each sheet 50 weight is light enough for one operator to position easily and attach to the mudsill. Although light weight and facile to maneuver into proper position, the sheet material with preferred embodiment becomes incredibly strong and unmovable once in position.

Once a length of sheeting 50 has been attached, the brackets can begin to be installed. The guidelines to determine how many brackets FIG. 2 will be sufficient for the job is simple to determine. In general, brackets are installed approximately every two feet (60.96 cm) apart. In particular, enough brackets FIG. 2 must be positioned so there is a bracket wherever a J-Bolt 90 would be required in the mudsill 60, at each juncture of two meeting sheet lengths regardless of either side of the enclosure, and at the end of a sheet length. Each main bracket FIG. 2 is fastened into position over the mudsill 60 and against the outer sheeting 50. The main bracket FIG. 2 is attached with wood screws 80. The two wood screw holes 81 on the top piece 17 of the main bracket FIG. 2 will be used to pass wood screws 80 through the bracket and into the mudsill 60 as in FIG. 6E (top view). Continue attaching rigid plywood sheets 50. Follow by attaching additional main brackets FIG. 2 approximately every two feet (60.96 cm) as in FIG. 6F (side view) along the rigid plywood sheeting 50. Stride main bracket FIG. 2 evenly over butted rigid plywood sheets 50 as in FIG. 6F. The purpose of fitting the sheet lengths tightly is two fold. First, it is to prevent leakage later from the concrete mixture 180 poured. Second, a bracket can be positioned over the two sheets to prevent warping from the concrete movement. As the main brackets FIG. 2 are secured FIG. 61D (end view) and FIG. 6F, installation moves rapidly and a number of processes can occur. Standard side supports 40 can be adjusted into the preferred position FIG. 1 and attached with pin bolts 21 to the end pieces 19 that fit against the outer sheeting FIG. 6G. Slip one standard support 40 over one end piece 19 lining up the holes 22A with 32A and insert a pin bolt 21. Then insert another pin bolt 21 at holes 32B with 22B. Continue attaching standard side supports 40 as seen in FIG. 6G end view on outside perimeter of all main brackets FIG. 2. Secure this portion of the assembly to the outer sheeting with wood screws 80 where the support wood screw holes 83A line up with the end piece 19 wood screw holes 81. Wood screws 80 are to be long enough to pass through the main bracket and into the sheeting but not pierce through the sheeting and into the inner enclosure being formed. Continue attaching sheets to the outside mudsill 60 perimeter, followed by attaching main brackets FIG. 2, then attaching the standard side supports 40, and securing to outer sheeting, FIG. 6G, following the recommended distances and suggestions for proper placement as mentioned above.

At this same time, J-Bolt holes 94 can be drilled. Use the attached main bracket FIG. 6E as a guide and with a conventional tool, drill the appropriately sized J-Bolt hole 94 through the mudsill 60. Code requirements will determine if the hole size should be either 5/8 inch (15,875 mm) or 1/2 inch (12.7 mm). Secure a nut 92 onto the J-Bolt 90 at the bottom the J-Bolt's threads and pass the remaining bolt threads up through the mudsill 60 and top piece 17 of the bracket. Another nut 92 is screwed down snugly over the end of the protruding J-Bolt threads to meet snugly the top piece 17 of the bracket as in FIG. 6A front view. The J-Bolt 90 is now in its secured position. The main bracket FIG. 1 insures that the J-Bolt 90 remains secure in its proper position as seen in FIG. 6A. The J-Bolt 90 is what holds the structure to the foundation. The main bracket FIG. 1 also holds the J-Bolt 90 in a vertical position that otherwise without this bracket support, might move during the pressure of the flow of concrete. Continue drilling J-Bolt holes 94 where required on the mudsill 60, using the attached positioned brackets as guides and repeat the steps for attaching the J-Bolts 90. Once the J-Bolts 90 are in place, the structural steel can be installed as to specification code. The bracket not only supports the outside structured sheet form, but it provides a guide and an openness that facilitates in the installation and positioning for the structural steel. Because code regulations vary, that information has not been included. The structural steel also has no bearing on the operation of the invention and is therefore unnecessary to include in the explanation of the apparatus operation.

Now the inside perimeter wall form is ready to be constructed to complete the enclosure. Start at any attached bracket. Begin by slipping a standard support 40 over one inner perimeter end piece 19 lining up the holes 22A with 32A and insert a pin bolt 21. Then insert another pin bolt 21 at holes 32B with 22B. This process will be repeated for each inside perimeter end piece 19. Now the bracket assembly looks like FIG. 1. Start to attach rigid plywood sheets 50 with wood screws 80 at available openings along the broad side of the bracket. Make sure wood screws 80 do not pierce through sheeting. Make sure rigid plywood sheets 50 butt together, which is also for the same reason as for the outside sheets, namely for preventing concrete leakage. If sheets are butt together in a place that a preferred embodiment FIG. 1 does not stride, add an additional bracket assembly at this point where the two sheets butt together to serve as reinforcement along the butted seam line to prevent buckling from the flowable concrete mixture 180. Wherever the bracket strides a butted sheet seam, make sure that in fastening that a screw is attached to each of the butted sheets. The paired wood screw holes 83A with 81 allow for this. Continue connecting all rigid plywood sheeting 50 with wood screws 80 at available wood screw holes 83A with 81 on the broad side of the embodiment to achieve the enclosure FIG. 6 (perspective) and 6A (front) views. The embodiment attached to the rigid sheets provides sufficient resistance to buckling from the flowable concrete mixture 180 and maintains the desired location of the enclosure to produce a relatively smooth wall finish.

By design, the preferred embodiment FIG. 1, once in place along with the laterally spaced suspended plywood sheeting 50 forming a relatively enclosed space as in FIG. 6, allows for a flowable concrete mixture 180 to be introduced between the rigid plywood sheeting 50 on the inside perimeter across the top opening 150 of the enclosure FIG. 6B. The width of the opening at the top is approximately four inches (101.6 mm) and varies slightly if a thicker rigid sheet element 50 such as 3/4 inch (19.05 mm) is used or variations in mudsill 60 width from the lumbermill. The mudsill 60 is a 2 inch (50.8 mm) thick by 4 inch (101.6 mm) width board but may vary slightly to be narrower depending on how the lumber is cut from the mill. These measurement variations make negligible differences to the bracket's strength or operation. With the preferred embodiment FIG. 1 positioned for an inside pour FIG. 6, the opening of the enclosure 150 runs the length of the perimeter on the inside of the building FIG. 6 to allow for easy access.

### Alternatives

The invention is versatile. Reversing the bracket and assembly is just as easy and sometimes advisable if pouring from beneath the building is too difficult. If pouring of concrete mixture is more desirable from outside the perimeter of the new mudsill 60, begin by attaching the sheeting to the side that is on the inside of the new mudsill 60 as in FIG. 6C and reversing the bracket assembly to allow the pouring of the concrete mixture 180 to be flowed from outside the perimeter. When the concrete is to flow from outside the perimeter of the foundation within the enclosed space, then begin the rigid plywood sheeting 50 suspension to the inside perimeter and top edge of the new mudsill 60 with wood screws 80 every two feet (60.96 cm). Screw rigid plywood sheeting 50 across the inside perimeter of the mudsill 60 and butting lengths of sheets together. The purpose of butting the sheeting edges is to reduce concrete leakage between the margins of the sheeting during the pouring. Continue attaching rigid plywood sheeting 50 either along a length of one side of the building's inner mudsill 60 or continue to cover the full inside perimeter of the new mudsill 60. Now install as many necessary main brackets FIG. 2 with standard side support FIG. 3, but in a reverse position FIG. 6C. Attach bracket with wood screws in the same manner across the top piece 17 of FIG. 2 and through aligned wood screw holes of attached side support 83A and passing through end piece 19 wood screw holes 81 and into sheet but not piercing through into the enclosure.

A flow of concrete mixture 160 may be pumped into the opening at the top of the enclosure 150. Because the sheeting is suspended by the embodiment at or above the site surface 130, the concrete mixture 180 flows down and out into the trench 140 and is unable to adhere to the sheeting 50. Once initial cure time for the concrete has passed, the brackets FIG. 1 and sheeting 50 can be dismantled easily and quickly to be used again for another foundation project.

### FIGS. 4-5

The embodiment is adjustable to be used for foundations that will be supporting a two-story or three-story building. FIG. 4 and FIG. 5 bear a close resemblance to FIG. 1, and thus the components of FIG. 4 and FIG. 5 are identical to those of FIG. 1. The differences are in the adjustment settings for the side supports 40, and the height of the rigid plywood sheets 50 that would be cut to accommodate taller foundations for taller buildings. The adjustment settings for the pin bolts 21 on a two-story and three-story foundation were previously discussed in FIG. 4-5—Additional Embodiment Assemblies on page 8. A two story foundation would use sheets 50 that are two feet (60.96 cm) high. A three story foundation would use sheets 50 that are three feet high (91.44 cm).

### CONCLUSIONS, RAMIFICATIONS, AND SCOPE

The apparatus and method I have provided for forming new foundations onto pre-existing buildings operates simply, efficiently, rapidly, uses a simple device, is easy to maintain, is re-usable and conserves on normally wasted material.

Thus the reader will see that I have provided a method that utilizes an invention to comprise the steps of:

providing a foundation form assembly comprising a bracket assembly and rigid sheet form element.

supporting a laterally butted together rigid sheet form element at the upper foundation surface which is suspended to the lowest timber of the foundation assembly.

supporting a continuous elongated enclosure at the lowest timber of the foundation assembly, and

supplying a flowable and settable foundation material to essentially fill the space within the elongated enclosure between the sheet forms so that the foundation material extends essentially continuously from trenched location below site surface to top of the lowest timber of foundation surface thereof so as to support the floor assembly when the material is set.

Preferably, the method is further characterized by the bracket restricting the rigid sheet form element from excessive movement from the force of the foundation mixture such that, when the foundation mixture within the elongated enclosure rests in the trench below the site surface, the width of the container as measured generally traversal to the foundation wall is greater than the spacing between the two sides of the rigid sheet form element.

The method is further characterized by:

connecting a plurality of brackets at spaced intervals along the foundation form assembly to extend downwardly therefrom, and

connecting the inner and outer suspended rigid sheet form element to the bracket to restrict said excessive movement of the rigid sheet form element from force from the foundation material.

permitting a pour of foundation mixture from either the inside of the perimeter of the foundation form assembly or the outside of the perimeter of the foundation form assembly.

What is claimed is:

1. A foundation form assembly for preexisting buildings comprising:
(a) a plurality of form brackets for spacing longitudinally apart along an axis of a foundation wall to be constructed, each bracket having a width defined by laterally spaced apart inner and outer edges of the bracket, which edges are also spaced longitudinally apart from corresponding edges of other brackets, each bracket is to be located to extend generally transversely of the axis of the lowest timber of the building so as to extend across corresponding width of the lowest timber of the building so that the inner edges of the bracket are disposed on opposite sides of the axis, and
(b) a rigid sheet form element for positioning and suspending along the axis of the lowest building timber and the inner side of the bracket and for forming into a generally parallel line shaped cross section so that the sheet form element has outer portions for connecting to at least upper portions of the inner edges respectively of the plurality of brackets at locations which are longitudinally spaced apart along the rigid sheet form element, the generally parallel line shaped cross section of the sheet form element also having a lower portion below the plurality of brackets and contiguous with the upper portion to extend as a substantially continuous elongated enclosure.

2. The assembly as claimed in claim 1, in which:
(a) the elongated enclosure formed from the sheet elements may extend downward no farther than the site surface located beneath the bracket, the enclosure having a lateral width which is equal to the width of the inside edges of the bracket minus the thickness of the attached rigid sheet form elements.

3. The assembly as claimed in claim 1, in which:
(a) the rigid sheet form element is sufficiently sturdy and inflexible once attached against the bracket, and
(b) each bracket has sufficient stiffness to be self-supporting when disposed generally vertically in an operative position to form a substantially plane, open framework extending over the width of the lowest timber and supporting the rigid sheet form elements that form the enclosure.

4. The assembly as claimed in claim 1, in which each bracket comprises:
(a) a supporting frame having columns which are elongated straight members connected to a top horizontal piece to form a single unit U-shape and having inwardly facing surfaces which provide the inner edges respectively of each bracket to contact the outer portions respectively of the rigid sheet form elements and lowest building timber, the main bracket frame also having two adjustable overlapping three-quarter columns connected by small rods and such overlapping three-quarter columns which are substantially straight elements extending over the outer face and sides of each column to connect and lengthen the columns for various foundation heights and forming.

5. The assembly as claimed in claim 4, in which:
(a) the columns of each bracket are generally vertical and parallel to each other, and
(b) the overlapping connecting three-quarter columns to the columns are parallel to each other when connected to bracket columns and generally extend parallel, supported horizontally by small rods, and adjustable on the framework, and
(c) the columns can be lengthened by changing the positions of the three-quarter columns on the bracket framework.

6. The assembly as claimed in claim 1, in which the rigid sheet form element comprises:
(a) a rigid sheet form, which is substantially non-permeable to water to restrict water against draining therethrough, being connectable to both inner edges of the bracket elongated straight column members.

7. The assembly as claimed in claim 1, in which each bracket further comprises:
(a) a plurality of connectors which cooperate with the inner and outer edges of the bracket including attached adjustable supports so as to secure the rigid sheet form element to the inner edges respectively of the bracket and also the lowest building timber, and
(b) a plurality of hooked metal rods supported by the brackets which have been placed at specified intervals and these rods being secured vertically at the lowest timber and bracket as each rod passes through an opening made in the lowest timber and corresponding to the opening in the bracket that is centered over the width of the lowest timber.

8. A method of constructing a building foundation wall, comprising the steps of:
(a) temporarily supporting a floor assembly of a building at the final level above site surface, and
(b) removing old building foundation and lowest building timber and replacing with a new building timber, and
(c) digging a projecting base below the site surface to follow the path of the new foundation wall and which such projecting base does not require any forming and whose width is wider than the proposed foundation and serves to act as a projecting base for the foundation wall, and
(d) using fasteners to position longitudinally extending rigid sheet form elements laterally along the outer side of the lowest timber of the floor assembly, and
(e) using additional fasteners to connect a plurality of form brackets at longitudinally spaced apart intervals along the floor assembly so that the brackets pass over and connect to the lowest timber with fasteners and extend downwardly from the floor assembly,
(f) using a plurality of hooked metal rods passing vertically through an opening in the brackets and center width of the lowest timber and which each hooked metal rod further connects to other metal reinforcement to be applied and
(g) connecting adjustable side supporting elements with small rod connectors to all brackets to form a complete assembly connecting to the outer lateral rigid sheet form element with fasteners, and
(h) using additional rigid sheet form elements connected to portions of the inwardly facing edges of the plurality of connected assemblies on the inner opposite side with fasteners so that the inner longitudinal sheet form elements laterally hang supported downwardly while suspended from the assemblies, and on other outer side of the assemblies, similar longitudinal rigid sheet form elements are formed laterally to create somewhat of an enclosed space and locating both sheet elements to extend as a substantially continuous elongated container following the line of the lowest timber and hanging downwardly but not so low as to extend into the base area which is below the site surface, and
(g) supplying a flowable and settable foundation material to substantially fill the space within the elongated container and between the portions of the rigid sheet form element so the rigid sheet form element is held firm and the weight of the foundation material is displaced downwardly to rest within the projecting base below the site surface so that the foundation material extends substantially continuously upwardly from projecting base below the site surface to the upper surface of the lowest building timber which is substantially in contact with and supportive of the building when the foundation material has set.
